(19) United States
(12) Patent Application Publication
(10) Pub. No.: US 2011/0037013 A1
(43) Pub. Date: Feb. 17, 2011

(54) COATINGS COMPRISING ITACONATE LATEX PARTICLES AND METHODS FOR USING THE SAME

(75) Inventors: Kaliappa G. Ragunathan, Gibsonia, PA (US); David R. Fenn, Allison Park, PA (US); Umesh C. Desai, Wexford, PA (US); Gregory J. McCollum, Gibsonia, PA (US); Anthony Palermo, Gibsonia, PA (US)

Correspondence Address: PPG INDUSTRIES INC;INTELLECTUAL PROPERTY DEPT, ONE PPG PLACE, PITTSBURGH, PA, 15272, US

(73) Assignee: PPG Industries Ohio, Inc., Cleveland, OH (US)

(21) Appl. No.: 12/541,396

(22) Filed: Aug. 14, 2009

(51) Int. Cl. E04B 1/74; C08F 297/02; C08L 31/00; C08K 3/26; B05D 3/02; B32B 27/28; C08K 3/34

(52) U.S. Cl. 252/62; 525/242; 524/559; 524/425; 524/424; 427/385.5; 428/522; 524/449; 524/456

(57) ABSTRACT

Coatings comprising a latex particle comprising the reaction product of itaconic acid/anhydride and a monoalcohol, a monoepoxide, a monoamine or mixtures thereof are disclosed. Methods for using such coatings, particularly for inhibiting sound and/or vibration transmission through a substrate, are also disclosed.

### FIELD OF THE INVENTION

The present invention relates generally to coatings comprising a latex particle comprising the reaction product of itaconic acid/anhydride and a monoalcohol, a monoepoxy and/or a monoamine, and methods for using such coatings.

### BACKGROUND OF THE INVENTION

Automobile manufacturers have tried in recent years to reduce material costs, and one way of doing so is to use thinner gauge metal sheets for automotive body panels and other parts. While providing initial raw material cost savings, the thinner gauge metal presents some drawbacks. Thinner metals have less impact strength and also have lower sound and vibration damping capacity. To overcome these drawbacks, automotive manufacturers have begun to apply sound and vibration damping, anti-flutter, and body panel reinforcement (BPR) coatings to the inside of body panels. Coatings on floorpans, firewalls, insides of door panels, and deck lids can be used to dampen or reduce road and engine noise, preventing sounds from traveling into the passenger compartment of the motor vehicle. Likewise, anti-flutter compositions are commonly used to prevent vibrations of doors and deck lids. They are usually extruded as beads or drops, often called “chocolate drops” in the industry, between reinforcing metal bars and the body panel. By varying the types and amounts of components, these compositions can provide different degrees of expansion and strength from the very soft to the very hard. The coatings that have been developed for the above purposes are sometimes solid laminate pre-cut sheets or pads that must be hand-applied to a substrate. Only small areas can be covered at one time, making the application of the layers time consuming and expensive. Other coatings that have been developed for the above purposes can be extruded or sprayed onto the substrate, but may deform the metal upon curing, creating a visible defect on outer painted surfaces. In some cases it is visible only at cold temperatures. This phenomenon is often referred to as “print-through”, “read-through”, “telegraphing” and/or “ghosting”. Such appearance defects are obviously undesirable.

The price of raw materials used in many manufacturing processes continues to rise, particularly those whose price rises or falls with the price of oil. Because of this, and because of the predicted depletion of oil reserves, raw materials derived from renewable resources or alternative resources may be desired. An increase in demand for environmentally friendly products, together with the uncertainty of the variable and volatile petrochemical market, has promoted the development of raw materials from renewable and/or inexpensive sources.

Coatings that can be used to provide sound and/or vibration damping and/or print-through resistance that are based on raw materials derived from renewable resources or alternative resources would therefore be desirable.

### SUMMARY OF THE INVENTION

The present invention is directed to a coating comprising a latex particle comprising the reaction product of itaconic acid/anhydride and a monoalcohol.

The present invention is further directed to a coating comprising a latex particle comprising the reaction product of itaconic acid/anhydride and a monoepoxide.

The present invention is further directed to a coating comprising a latex particle comprising the reaction product of itaconic acid/anhydride and a monoamine.

The present invention is further directed to a coating comprising a latex particle comprising the reaction product of itaconic acid/anhydride and monoalcohol, monoepoxide and/or monoamine.

Coatings comprising such compositions and methods for using such compositions are also the subject of the present invention.

### DETAILED DESCRIPTION OF THE INVENTION

The present invention is directed to a coating comprising latex particles. The latex particles are the reaction product of itaconic acid and/or itaconic anhydride, sometimes referred to herein as “itaconic acid/anhydride”, and a monoalcohol, monoepoxide and/or monoamine. “Reaction product” as used herein in reference to a latex particle refers to the product that results from polymerization of itaconic acid/anhydride with the monoalcohol, monoepoxide, and/or monoamine.

It will be appreciated by those skilled in the art that itaconic acid has two acid-functional groups, or residues thereof, such as anhydride groups. Itaconic acid/anhydride is commercially available from Cargill, Aldrich, Acros, and the like. Itaconic acid/anhydride comprises ethylenic unsaturation, which may make it suitable for use in a radiation-curable coating, and/or provide the location for polymerization with other monomers that also contain ethylenic unsaturation. As used herein, a compound that contains “ethylenic unsaturation” is one that has at least one reactive double bond. In certain embodiments, it will be appreciated that the itaconic acid/anhydride can be biomass-derived. As used herein, the term “biomass-derived” refers to being derived from a living or recently living organism, for example, plants (including trees) or animals and not from a petroleum-based source.

Any monoalcohol can be used according to the present invention. As used herein, the term “monoalcohol” refers to an alcohol having only one hydroxy functionality. It will be appreciated by those skilled in the art, however, that a monoalcohol can have one or more other reactive functional groups, or sites for reaction with other compounds. Monoalcohols with any number of carbon atoms can be used. Examples of suitable monoalcohols include, but are not limited, 2-ethylhexanol, cyclohexanol, ethanol, methanol, propanol, butanol, pentanol, hexanol, octanol, lauryl alcohol and stearyl alcohol.

The acid/anhydride functionality of the itaconic acid/anhydride will react with the monoalcohol to form an ester linkage. This reaction product is sometimes referred to herein as the “itaconic acid/anhydride ester”. The itaconic acid/anhydride ester will still have ethylenic unsaturation. This site of ethylenic unsaturation can be further reacted with other monomers or polymers having functionality and/or ethylenic unsaturation. Accordingly, in certain embodiments, the itaconic acid/anhydride ester is reacted with (meth)acrylate and/or another compound having ethylenic unsaturation. In this manner, the compound(s) having ethylenic unsaturation become reacted with the itaconic acid/anhydride ester.

Any monoepoxide can be used according to the present invention. As used herein, the term “monoepoxide” refers to a compound, oligomer, polymer, or the like, comprising one epoxy-functional group. The monoepoxide can have one or more other reactive functional groups, or sites for reaction with other compounds. It will be appreciated that the epoxy will react with the acid/anhydride group on the itaconic acid/anhydride to result in a reaction product having hydroxy functionality. Suitable monoepoxides include reaction products of monoalcohol and epichlorohydrinnoe, e.g. n-butyl glycidyl ether, 2-ethyl hexyl glydidyl ether, phenyl glycidyl ether, O-cresyl glycidyl ether, nonylphenol glycidyl ether, glycidyl esters of monocarboxylic acids e.g. 2,3-epoxy propyl neodeconoate, glycidyl acetate, glycidyl propionate, glycidyl butanoate and the like.

Any monoamine can be used according to the present invention. As used herein, the term “monoamine” refers to a compound, oligomer, polymer or the like comprising one amine group. The monoamine can have one or more other reactive functional groups, or sites for reaction with other compounds. It will be appreciated that the amine will react with the acid/anhydride group on the itaconic acid/anhydride to result in a reaction product having amide functionality. Suitable monoamines include ethylamine, diethylamine, butylamine, dibutylamine, pentylamine, dipentylamine, hexylamines, dihexylamine, heptylamine, diheptylamine, octylamine and dioctylamine.

In certain embodiments, one or more monoalcohols, one or more monoepoxides and/or one or more monoamines can all be used to prepare the particles. Combinations of particles prepared from different monomers can also be used together. Latex particles comprising other materials can also be used in combination with those described herein, such as latex particles comprising (meth)acrylate.

Preparation of the latex particles can be by any means known in the art. For example, the latex particle can be formed upon polymerization of the itaconic acid/anhydride and the monoalcohol, monoepoxide and/or monoamine. Latex particle synthesis by emulsion polymerization is well known in the art and several procedures are outlined in U.S. Pat. No. 6,531,541, column 8, line 20 to column 9, line 32, which excerpts are incorporated herein by reference.

In certain embodiments, the coatings of the present invention can further comprise an additional component, such as one comprising ethylenic unsaturation. Examples of suitable compounds comprising ethylenic unsaturation include, but are not limited to, (meth)acrylate, alkyl(meth)acrylate, (meth)acrylic acid, styrene, acrylonitrile, acrylamide, vinyl acetate, and combinations thereof. As used herein, “(meth)acrylate” and like terms refers to both acrylate and the corresponding methacrylate.

The latex particles according to the present invention will typically have an average particle size of 20 to 500 nm, such as 50 to 250 nm or 70 to 200 nm.

The glass transition in temperature (“Tg”) of the latex particles ranges from about −60° C. to +120° C., such as −20° C. to +80° C. or −10° C. to +50° C. Tg is determined by differential scanning calorimetry. In certain embodiments, a blend of latex particles having different Tgs can be used to achieve sound and/or vibration damping over a broad temperature range. For example, by using particles that have peak sound and/or vibration damping at a lower temperature blended with particles that have peak sound and/or vibration damping at a higher temperature, good sound and/or vibration damping over a wider temperature range can be achieved.

In certain embodiments, the coatings comprising any of the latex particles described above can be used on a substrate, such as is described below. The coatings of the present invention may comprise 5 weight percent or greater of latex particles, such as 10 weight percent or greater, 20 weight percent or greater, 30 weight percent or greater, 40 weight percent or greater, or 50 weight percent or greater with weight percent based on 100% solids coatings composition. In certain embodiments, the coatings of the present invention will comprise between 5-25 weight percent of latex particles, such as 10-15 weight percent. As used herein, “weight percent” refers to the total solid weight of the coating.

The coating compositions of the present invention can further comprise one or more polymeric film-forming materials including, for example, polyepoxide, polyurethane, polyamide, polyester, polyether, polybutadiene, polyacrylate, polyvinyl chloride and mixtures and/or copolymers thereof.

Useful polyepoxides may have at least two epoxide or oxirane groups per molecule and include epoxy-functional oligomers, polymers and/or copolymers. Generally, the epoxide equivalent weight of the epoxy-functional polymer can range from about 70 to about 4,000, as measured by titration with perchloric acid and quaternary ammonium bromide using methyl violet as an indicator. Suitable epoxy-functional polymers can be saturated or unsaturated, cyclic or acyclic, aliphatic, alicyclic, aromatic or heterocyclic. The epoxy-functional polymers can have pendant or terminal hydroxyl groups, if desired. They can contain substituents such as halogen, hydroxyl, and ether groups. A useful class of these materials includes polyepoxides comprised of epoxy polyethers obtained by reacting an epihalohydrin (such as epichlorohydrin or epibromohydrin) with a di- or polyhydric alcohol in the presence of an alkali, such as diglycidyl ethers of bisphenol A, for example, EPON 828 epoxy resin, which is commercially available from Shell Chemical Company.

Useful thermoplastic polymeric film-forming materials include polyvinyl acetate; aromatic vinyl polymers; vinyl copolymers having vinyl aromatic hydrocarbons as monomer components such as polystyrene, styrene-butadiene copolymers, styrene-divinylbenzene copolymers and styrene-acrylonitrile copolymers; saturated polyesters including saturated aliphatic polyesters such as polyneopentyl adipate, polypropylene adipate and poly epsilon-caprolactone; polyacrylates such as polyalkyl(meth)acrylates having alkyl groups with 1-8 carbon atoms, polymethacrylates or polyalkyl(meth)acrylates obtained by polymerization of methyl methacrylate, isobutyl methacrylate and 2-ethylhexyl acrylate; saturated polyester urethanes, polybutadienes; polyvinyl chlorides and polyvinyl chloride/acetates. Useful substantially saturated polyesters are prepared from polyfunctional acids and polyhydric alcohols by methods such as are disclosed in U.S. Pat. No. 4,739,019 at Column 3, Line 22 through Column 5, Line 15, which excerpt is incorporated by reference herein.

In one embodiment, a polyacrylate film-forming material such as a polyacrylate copolymer emulsion prepared from methyl acrylate, butyl acrylate, methyl methacrylate and methacrylic acid is included in the coating composition. Such a product is commercially available from BASF Corporation as ACRONAL DS 3502. Other acrylate monomers that may be used as film formers include butyl methacrylate, acrylic acid, styrene, cycloalkyl(meth)acrylates, such as those having 4 to 8 carbons, hydroxy alkyl(meth)acrylates, such as those having one to four carbons, and ethylhexylacrylate (“EHA”). Any other (meth)acrylate known in the art can be used.

The film-forming material, if used, is typically present in the coating composition in an amount ranging from about 1 to about 40 percent by weight based on the total solids of the composition, such as about 5 to about 30 percent by weight.

In certain embodiments, any of the latex particles described above can be added to conventional sound and/or vibration damping coatings. Examples of such coatings are described in U.S. Pat. No. 6,531,541, hereby incorporated by reference in its entirety. For example, some or all of the (meth)acrylate in such coatings can be replaced with any one or more of the latex particles described above, particularly those comprising (meth)acrylate.

The coatings of the present invention can further comprise one or more fillers for improving the sound and/or vibration dampening capabilities of the coating. Also, density differences between the filler and latex may help dissipate sound and/or vibration energy throughout the film, as measured by Oberst density. Even distribution of the filler between the latex particles can provide better acoustic properties, and the filler may also further help to suppress mechanical vibration of the substrate and thereby inhibit sound and/or vibration transmission. Useful fillers include mica, powdered slate, montmorillonite flakes, glass flakes, metal flakes, graphite, talc, iron oxide, clay minerals, cellulose fibers, mineral fibers, carbon fibers, glass or polymeric fibers or beads, ferrite, calcium carbonate, calcium magnesium carbonate, such as that sold under the name DOLOCRON by Mineral Technologies, barytes, ground natural or synthetic rubber, silica, aluminum hydroxide, alumina powder, VANSIL, which is wollastonite sold by R. T. Vanderbilt, Co., and mixtures thereof. The filler material can comprise about 20 to about 90 weight percent of the coating, based on the total solids weight of the coating, such as about 50 to about 80 weight percent. In one embodiment, the latex particles comprise about 10 weight percent of the composition and the filler and other additives comprise about 90 weight percent.

Additionally, one or more plasticizers can be included in the coatings of the present invention. Non-limiting examples of suitable plasticizers include adipates, benzoates, glutarates, isophthalates, phosphates, polyesters, sebacates, sulfonamides, alkyl benzyl phthalates, and terephthalates. The amount of plasticizer can range from about 0.1 up to about 50 weight percent, such as 0.1 to 10 weight percent, of the total solid weight of the composition.

The coatings of the present invention can further include a variety of optional ingredients and/or additives, depending on the desires of the user, such as one or more colorants, such as carbon black or graphite. As used herein, the term “colorant” means any substance that imparts color and/or other opacity and/or other visual effect to the composition. The colorant can be added to the coating in any suitable form, such as discrete particles, dispersions, solutions and/or flakes. A single colorant or a mixture of two or more colorants can be used in the coatings of the present invention.

Other suitable colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the coatings by grinding or simple mixing. Colorants can be incorporated by grinding into the coating by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black, carbon fiber, graphite, other conductive pigments and/or fillers and mixtures thereof. The terms “pigment” and “colored filler” can be used interchangeably.

Example dyes include, but are not limited to, those that are solvent and/or aqueous based such as acid dyes, azoic dyes, basic dyes, direct dyes, disperse dyes, reactive dyes, solvent dyes, sulfur dyes, mordant dyes, for example, bismuth vanadate, anthraquinone, perylene, aluminum, quinacridone, thiazole, thiazine, azo, indigoid, nitro, nitroso, oxazine, phthalocyanine, quinoline, stilbene, and triphenyl methane.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

As noted above, the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm. Nanoparticles can be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in U.S. application Ser. No. 10/876,031 filed Jun. 24, 2004, which is incorporated herein by reference, and U.S. Provisional Application No. 60/482,167 filed Jun. 24, 2003, which is also incorporated herein by reference.

Example special effect compositions that may be used in the coating of the present invention include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as reflectivity, opacity or texture. In a non-limiting embodiment, special effect compositions can produce a color shift, such that the color of the coating changes when the coating is viewed at different angles. Example color effect compositions are identified in U.S. Pat. No. 6,894,086, incorporated herein by reference. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In certain non-limiting embodiments, a photosensitive composition and/or photochromic composition, which reversibly alters its color when exposed to one or more light sources, can be used in the coating of the present invention. Photochromic and/or photosensitive compositions can be activated by exposure to radiation of a specified wavelength. When the composition becomes excited, the molecular structure is changed and the altered structure exhibits a new color that is different from the original color of the composition. When the exposure to radiation is removed, the photochromic and/or photosensitive composition can return to a state of rest, in which the original color of the composition returns. In one non-limiting embodiment, the photochromic and/or photosensitive composition can be colorless in a non-excited state and exhibit a color in an excited state. Full color-change can appear within milliseconds to several minutes, such as from 20 seconds to 60 seconds. Example photochromic and/or photosensitive compositions include photochromic dyes.

In a non-limiting embodiment, the photosensitive composition and/or photochromic composition can be associated with and/or at least partially bound to, such as by covalent bonding, a polymer and/or polymeric materials of a polymerizable component. In contrast to some coatings in which the photosensitive composition may migrate out of the coating and crystallize into the substrate, the photosensitive composition and/or photochromic composition associated with and/or at least partially bound to a polymer and/or polymerizable component in accordance with a non-limiting embodiment of the present invention, have minimal migration out of the coating. Example photosensitive compositions and/or photochromic compositions and methods for making them are identified in U.S. application Ser. No. 10/892,919 filed Jul. 16, 2004 and incorporated herein by reference.

In general, the colorant can be present in the coating composition in any amount sufficient to impart the desired property, visual and/or color effect. The colorant may comprise from 1 to 65 weight percent of the present compositions, such as from 3 to 40 weight percent or 5 to 35 weight percent, with weight percent based on the total weight of the compositions.

Other additives include reinforcements, thixotropes, accelerators, surfactants, extenders, stabilizers, corrosion inhibitors, diluents, blowing agents and/or antioxidants. Suitable thixotropes include fumed silica, bentonite, stearic acid-coated calcium carbonate, fatty acid/oil derivatives and associative urethane thickeners such as RM-8, which is commercially available from Rohm and Haas. Thixotropes, if used, are generally present in an amount of up to about 20 weight percent of the total solid weight of the composition. Optional additional ingredients such as carbon black or graphite, blowing agents, expandable polymeric microspheres or beads, such as polypropylene or polyethylene microspheres, surfactants and corrosion inhibitors like barium sulfonate, if used, are generally present in an amount of less than about 5 weight percent of the total solid weight of the composition. Low molecular weight polyols like propylene glycol, polypropylene glycol, ethylene glycol, and polyethylene glycol could also be used. Latex particle coalescing solvents like butylcellosolve, butylcarbitiol, propasol B, DOWANOL DPM, DOWANOL PPh, DOWANOL DPnB, DOWANOL Eph and Eastman TEXANOL can also be used.

The viscosities of the present coatings are application-specific based on the type of equipment used, the desired film thickness and the sag resistance. Typically, the viscosity of the coating will be greater than 1000 centipoise (“cp”), and ranges from about 1000 to about 1,000,000 cp measured at 2 RPM with a #7 spindle Brookfield measurement. Sprayable coatings typically have viscosities below about 100,000 cp at 20 RPM reading on the Brookfield viscometer at ambient temperature (about 25° C.).

In certain embodiments, the composition will have appropriate viscosity to allow adequate atomization of the composition during spray application. The viscosity can be controlled partially by using thickeners, or by any means known in the art. Interactions among latex particles can affect the rheology of compositions containing them. They can be greatly affected by the ionic charge density on the surface of the particles. Charge density can be controlled by use of an acid comonomer.

Substrates coated according to the present invention can include those formed from metal, polymers, such as thermoset materials and thermoplastic materials, and combinations of metal and polymeric substrates. Suitable metal substrates that can be coated according to the present invention include ferrous metals such as iron, steel, and alloys thereof, non-ferrous metals such as aluminum, zinc, magnesium, copper and alloys thereof, and combinations thereof. In certain embodiments, the substrate is formed from cold rolled steel, electrogalvanized steel such as hot dip electrogalvanized steel or electrogalvanized iron-zinc steel, aluminum or magnesium. Combinations of composites of ferrous and non-ferrous metals can also be used. The metal substrate to be treated can be bare, pretreated or prepainted (for example, by electrocoating) prior to application of the composition.

Thermoset materials useful for substrates coated according to the present invention include polyesters, epoxides, phenolics, polyurethanes such as reaction injected molding urethane (RIM) thermoset materials and mixtures thereof. Useful thermoplastic materials include thermoplastic polyolefins such as polyethylene and polypropylene, polyamides such as nylon, thermoplastic polyurethanes, thermoplastic polyesters, acrylic polymers, vinyl polymers, polycarbonates, acrylonitrile-butadiene-styrene (ABS) copolymers, EPDM rubber, copolymers and mixtures thereof.

The surfaces to which the present coatings can be applied in the methods of the present invention typically are non-Class A surfaces of substrates, typically automotive substrates. “Class A” surfaces are those surfaces that will become part of the most visible portions of the resulting article. For example, in automotive applications, Class A surfaces can include the outer portions of the door panels, hood, trunk, quarter panels, side panels, and the like, which are exposed directly to the weather and are readily visible to the consumer. “Non-Class A” surfaces are those surfaces that are destined for non-highly visible areas or even non-visible areas of the article, such as in the case of an automotive substrate, the inside of the door panel, the inside surface of the quarter and side panels, underneath the hood or trunk, etc. Although an aesthetic, durable finish is required for the Class A surfaces, applying such aesthetic finishes onto the non-Class A surfaces typically is not desirable because such coatings are costly and time-consuming to apply. However, the non-Class A surfaces are typically at least coated with an anticorrosion coating to prevent rust or corrosion. Moreover, it is noteworthy that the composition comprising latex particles applied to non-Class A surfaces in accordance with the methods of the present invention can, in some embodiments, affect the appearance of coatings applied to the opposing (Class A) surface by minimizing if not preventing print-through.

The thickness of the substrate can typically range from 0.25 to 3.18 millimeters (mm) (10 to 125 mils), such as from 0.6 to 1.2 mm (23.6 to 47.2 mils), although the thickness can be greater or less, as desired.

Before depositing any composition upon the surface of the substrate, it is common practice, though not necessary, to remove foreign matter from the surface by thoroughly cleaning and degreasing the surface. Such cleaning typically takes place after forming the substrate (stamping, welding, etc.) into an end-use shape. The surface of the substrate can be cleaned by physical or chemical means, such as mechanically abrading the surface or cleaning/degreasing with commercially available alkaline or acidic cleaning agents, which are well known to those skilled in the art, such as sodium metasilicate and sodium hydroxide. A non-limiting example of a cleaning agent is CHEMKLEEN 163, an alkaline-based cleaner commercially available from PPG Industries, Inc.

Following the cleaning step, the substrate may be rinsed with deionized water or an aqueous solution of rinsing agents in order to remove any residue. The substrate can be air dried, for example, by using an air knife, by flashing off the water by brief exposure of the substrate to a high temperature or by passing the substrate between squeegee rolls.

In the methods of the present invention, the substrate to be coated with the coating comprising latex particles may be a bare, cleaned surface; it may be oily, pretreated with one or more pretreatment compositions, and/or prepainted with one or more coating compositions, primers, etc., applied by any method including, but not limited to, electrodeposition, spraying, dip coating, roll coating, curtain coating, extrusion or by hand such as with a blade.

The coatings comprising the latex particles described herein can be used alone, or can be used in conjunction with other coatings. For example, a coating composition comprising a thermosetting (curable) or thermoplastic, or mixture thereof, resin can be used as the first coating. The first-applied coating composition may comprise any of a variety of polymers known in the art. For example, the polymer may be selected from acrylic polyester, polyurethane, polybutadiene, polyether, polycarbonate, polyamide, polyurea, polyglycidyl ethers of polyhydric alcohols, and/or polyglycidyl ethers of polyphenols. As used herein, the term “polybutadiene” is intended to include hydrogenated polybutadiene and epoxidized polybutadiene. When the first-applied coating composition is thermosetting, the polymer may comprise any of a variety of reactive functional groups. In an embodiment of the present invention, the polymer comprises reactive epoxy, isocyanate, blocked isocyanate, hydroxyl, acid, carbamate, and/or amino functional groups. A thermosetting coating composition typically further comprises at least one curing agent capable of reacting with the functional groups of the polymer. Such compositions are further described in U.S. Pat. No. 7,288,290, incorporated by reference in its entirety herein.

The coatings of the present invention can be applied directly to the substrate, or over a first-applied coating by any means standard in the art, such as any of those described above. If a first-applied coating composition is used, it can be dried, partially dried, or not dried at all prior to the application of the present compositions. If one or more of the present compositions is applied to the substrate over the first-applied composition, it can be “wet-on-wet”, with no drying or curing of the first-applied composition prior to application of the present compositions. Also, the first coating composition and the composition of the present invention can be coextruded onto the substrate, such as by coextrusion using a tandem nozzle applicator. It should be understood that the application method for the first-applied composition is independent of the method used to apply the present composition. For example, the first-applied composition may be applied by spraying and the present composition may be applied by extrusion, or vice versa, both may be applied by spraying, both by extrusion, or any other combination. Alternatively, after application of the first coating composition and before application of the present composition, the first-applied composition may be dried or cured. Suitable curing methods will be known to those skilled in the art, based upon the composition of the first coating, the substrate, the needs of the user, and the like. In yet another embodiment, more than one coating comprising a latex particle as described herein is applied to the substrate, either directly to the substrate, or in conjunction with one or more other layers, such as the first-applied coating composition used above. In a particular embodiment, one or more of the coatings described herein is applied over an ecoat.

After application of the present coating over the first-applied coating composition, one or both of the coatings are dried or cured. In an embodiment of the present invention, the substrate may be heated to a temperature and for a time sufficient to substantially cure one or both of the coating compositions to form a coating comprising latex particles on the substrate. The curing times and temperatures may be designed to allow curing of the composition comprising latex particles simultaneously with electrodeposited and/or decorative paints applied to the Class A surface of the substrate, and/or with the electrodeposited paint applied to the non-class A surface.

The compositions of the present invention, when applied to a substrate, can provide fast-drying, mudcrack resistant coatings that may inhibit sound and/or vibration transmission through the substrate. Dry film thickness can typically be about 15 mils to as high as about 200 mils.

The sound damping of coatings can be measured using the Oberst ASTM Test Method E756-98 (“Standard Test Method for Measuring Vibration—Damping Properties of Materials”), Sections 3 and 10. The principal measure of sound deadening in this test is loss factor, the ratio of loss modulus to storage modulus of the material. Oberst values typically range from 0.001 for uncoated steel (thickness 30 mils) (if the steel panel is struck, one would hear a “clang”) to 0.01 (“bong”) to 0.1 (“bunk”) to 0.5 (“thud”) for increasingly efficient coatings. It would be understood by those skilled in the art that the measured sound and vibration damping value may vary with total film thickness as well as the temperature or temperature range over which measurements are made. As noted above, different particles may have different sound and/or vibration damping at different temperatures; sound and/or vibration damping may also vary from particle to particle depending on, for example, the composition of the particle. The Oberst test measures the sound loss factor of the coating-substrate composite. Test samples are applied to an Oberst Bar, which is a metal bar formed from special oil-hardening ground flat stock, AISI/SAE GRD 0-1, 1/32 inch (0.8 mm) thick, ½ inch ( 1 2.7 mm) wide from McMaster-Carr, part number 89705-K 12 1 and cured.

The substrate coated by the methods of the present invention typically has a sound and/or vibration damping value of 0.05 or greater Oberst dissipation factor determined by ASTM E-756-98 over a wide temperature range. For example, a substrate coated with the present compositions may have a sound and/or vibration damping value of 0.05 or greater at a temperature range of at least 20° C. (such as 5° C. to 25° C., 0° C. to 20° C., −20° C. to 0° C. and the like), at least 30° C. (such as −5° C. to 25° C., −20° C. to 5° C. and the like) or at least 40° C. (such as 10° C. to 50° C.). It should be understood that for some end use applications a lower sound and/or vibration damping value may be acceptable. For example, for household appliances such as washers and dryers, a lower sound and/or vibration damping value might be acceptable. In such cases, a lower total dry film thickness such as 80 to 100 mil (at optimized film ratios) may be desirable, and typically will provide a sound and vibration damping value of 0.05 or greater Oberst dissipation factor.

Accordingly, the present invention is further directed to methods for inhibiting sound and/or vibration transmission through a substrate. The methods generally comprise applying to the substrate any of the coating compositions described above, and at least partially drying the coating. Application can be through any means known in the art, such as any of those described above. Drying can be effected by air drying or heating up to 200° C. using convection ovens or infra red radiation. After applying the aqueous coating composition of the present invention to the substrate surface, it may first be permitted to dry partially at ambient or slightly elevated temperature, followed by heating of the coated substrate.

In general, the coating composition of the invention finds application in the quarter panels, the roof, the door, the interior, the floor pan, and the wheel house of motor vehicles. In other applications, the coating composition can be used in a suitable position on the inside or outside of a structure, e.g., a vehicle or an aircraft or a building, to provide maximum sound damping performance.

In certain embodiments, the compositions comprising latex particles used in the methods of the present invention are not intended to include a laminate type composite; i.e., the coating compositions used therein do not comprise and are not applied to solid sheets, films, pads, patches, or panels to be subsequently applied to a substrate by compression, heat, or through the use of adhesives or the like. Rather, the compositions used in the methods of the present invention are liquid. By “liquid” is meant that the compositions have a viscosity that allows them to be at least extrudable. In one embodiment of the present invention, the compositions have a viscosity that allows them to be a least pumpable, and in other embodiments the compositions have a viscosity that allows them to be at least sprayable. The composition(s) of the present invention can be warm applied, for example, at a temperature of 50° C. to 60° C. to facilitate pumping and spraying.

As used herein, unless otherwise expressly specified, all numbers such as those expressing values, ranges, amounts or percentages may be read as if prefaced by the word “about”, even if the term does not expressly appear. Also, any numerical range recited herein is intended to include all sub-ranges subsumed therein. Singular encompasses plural and vice versa. For example, although reference is made herein to “a” latex particle, “a” monoalcohol, “a” monoepoxide, “a” monoamine, one or more of each of these and any other components can be used. As used herein, the term “polymer” refers to oligomers and both homopolymers and copolymers, and the prefix “poly” refers to two or more. Including and like terms means including but not limited to.

### EXAMPLES

The following examples are intended to illustrate the invention and should not be construed as limiting the invention in any way.

### Synthesis of Itaconic acid Di(2-ethyl hexyl)ester

A reaction flask was equipped with a stirrer, thermocouple, nitrogen inlet, and Dean-Stark distillation head. Itaconic acid 260.7 grams, 2-ethyl hexanol 534.0 grams, Xylene 100.3 grams, triphenyl phosphite 4.2 grams, IONOL 0.9 grams (free radical inhibitor from Cognis) were charged to the flask and this mixture was heated to 120° C. Xylene-water azeotrophe was collected and the xylene was returned to the flask. After 17 hours the reaction mixture was cooled to room temperature. The ester had an acid value of 10.8 and a % solids of 91.4.

### Synthesis of Latex

A reaction flask was equipped with a stirrer, thermocouple, nitrogen inlet, and a condenser. Charge A was added and stirred with heat to 80° C. under nitrogen atmosphere. A pre-emulsion of Feed D was prepared by mixing all the ingredients for 20 minutes. To charge A at 80° C., Feed B was added and stirred for 5 minutes. Then Feed C was added and stirred for 30 minutes. The remainder of Feed D and initiator Feed E were simultaneously added over three hours to the reaction mixture. The reaction mixture was stirred at 80° C. for an hour and subsequently cooled to 36° C. Then Feed F was added over five minutes followed by Feed G, which was added over five minutes. The latex dispersion was stirred for 20 minutes and filtered through 25 micron filter bags.

Polymer composition Table 1

| | EXAMPLE 1 | EXAMPLE 2 | EXAMPLE 3 |
|---|---|---|---|
| Charge A (weight in grams) | | | |
| De-ionized water | 717.4 | 717.4 | 422.8 |
| ALIPAL CO436¹ | 2.5 | 2.5 | 1.54 |
| Feed B (weight in grams) | | | |
| Pre-emulsion of Feed D | 12.1 | 12.1 | 12.1 |
| Feed C (weight in grams) | | | |
| De-ionized water | 8.7 | 8.5 | 5.3 |
| Ammonium persulfate | 0.4 | 0.4 | 0.3 |
| Feed D (weight in grams) | | | |
| De-ionized water | 202.9 | 202.9 | 119.3 |
| ALIPAL CO436 | 8.2 | 8.2 | 4.99 |
| Methyl methacrylate | 212.7 | 127.8 | 75.3 |
| 2-Ethylhexyl acrylate | 6.0 | — | — |
| 2-Hydroxyethyl methacrylate | 70.1 | 70.1 | 41.3 |
| Itaconic acid Di(2-ethyl hexyl)ester | — | 246.4 | 145.0 |
| n-Butyl acrylate | 301.4 | 145.6 | 28.7 |
| Methacrylic acid | 6.0 | 7.5 | 4.5 |
| n-Butyl methacrylate | — | — | 57.2 |
| Feed E (weight in grams) | | | |
| De-ionized water | 187.6 | 187.6 | 110.3 |
| Ammonium persulfate | 2.4 | 2.4 | 1.4 |
| Feed F (weight in grams) | | | |
| N,N-Dimethyl ethanolamine | 9.4 | 9.4 | 5.5 |
| De-ionized water | 9.7 | 9.7 | 5.7 |
| Feed G (weight in grams) | | | |
| De-ionized water | 4.4 | 4.4 | 2.6 |
| PROXEL GXL² | 6.2 | 6.2 | 3.6 |
| % solids | 33.9 | 33.9 | 33.8 |
| pH | 9.39 | 9.18 | 9.10 |

¹Surfactant available from Rhodia Inc
²Biocide available from Arch Chemicals

Coating compositions using each example were made by adding the respective latex, followed by the DOLOCRON, FOAMMASTER and ACRYSOL RM-8, as shown in Table 2, and mixing using a DAC SPEEDMIXER. The coatings were applied to an Oberst Bar measuring 9 inches (L)×0.5 inch (W)×0.032 inch (T) (22.86×1.27×0.081 cm). The test material was applied to an Oberst Bar with a template suitable to provide approximately 0.07 inch dry thickness. One inch (2.54 cm) of the bar on one end, commonly known as the root of the bar, was left uncovered. Bars were conditioned at least 10 days at room temperature before grinding the excess on edges to match the bar's dimensions. Composite Loss Factor (CLF) measurements were done according to ASTM E-756 using a Data Physics SignalCalc analyzer. Composite Loss factor (CLF) Measurements were taken for 2 to 5 modes with corresponding resonance frequencies at 10° C., 25° C., and 40° C. and are tabulated in Table 2.

Sound damping coating composition and performance (Table 2)

| | COATING 1 | COATING 2 | COATING 3 |
|---|---|---|---|
| Example 1 | 62.7 | — | — |
| Example 2 | — | 62.7 | — |
| Example 3 | — | — | 62.7 |
| FOAMMASTER³ | 0.1 | 0.1 | 0.1 |
| DOLOCRON⁴ | 140.0 | 140.0 | 140.0 |
| ACRYSOL | 0.2 | 0.2 | 0.2 |
| RM-8⁵ | | | |
| Coating weight | 7.89 | 6.46 | 7.32 |
| (grams) | | | |
| Oberst loss | | | |
| factor at +10 C. | | | |
| 2^{nd} mode | 0.051 (143 Hz) | 0.124 (108 Hz) | 0.081 (129 Hz) |
| 3^{rd} mode | 0.046 (422 Hz) | 0.124 (321 Hz) | 0.072 (377 Hz) |
| 4^{th} mode | 0.046 (853 Hz) | 0.117 (648 Hz) | 0.067 (757 Hz) |
| 5^{th} mode | — | 0.131 (1097 Hz) | — |
| Oberst loss | | | |
| factor at +25 C. | | | |
| 2^{nd} mode | 0.188 (120 Hz) | 0.084 (91 Hz) | 0.143 (120 Hz) |
| 3^{rd} mode | 0.170 (359 Hz) | 0.114 (264 Hz) | 0.138 (355 Hz) |
| 4^{th} mode | 0.143 (742 Hz) | 0.139 (533 Hz) | 0.141 (707 Hz) |
| 5^{th} mode | — | 0.149 (898 Hz) | — |
| Oberst loss | | | |
| factor at +40 C. | | | |
| 2^{nd} mode | 0.177 (99 Hz) | 0.055 (90 Hz) | 0.138 (103 Hz) |
| 3^{rd} mode | 0.227 (300 Hz) | 0.078 (260 Hz) | 0.178 (300 Hz) |
| 4^{th} mode | — | 0.096 (520 Hz) | 0.174 (622 Hz) |
| 5^{th} mode | — | 0.113 (878 Hz) | 0.178 (1047 Hz) |

³FOAMMASTER 111 = hydrocarbon defoamer available from Cognis
⁴Dolocron 4512 = Dolomite calcium magnesium carbonate available from Specialty Minerals
⁵Acrysol RM-8 = Rheology modifier available from Rhom & Hass

As discussed above, performance of sound and/or vibration damping is related to test temperature and Tg of the polymer. Typically, a polymer will exhibit good sound and/or vibration damping at one or more temperatures, but not all temperatures. As demonstrated in Table 2, the performance of the latex of the present invention (Examples 2 and 3) was consistent with this observation, performing well at two of the tested temperatures, but not as well at a third. Indeed, the performance of Coating 3 was similar to Coating 1, which coating is generally described in U.S. Pat. No. 6,531,541. Thus, the present latices, using a renewable resource, performed as well as a coating using non-renewable resources. A mixture of Coatings 2 and 3 would be expected to provide sound and/or vibration damping over the range 10° C. to 40° C.

Whereas particular embodiments of this invention have been described above for purposes of illustration, it will be evident to those skilled in the art that numerous variations of the details of the present invention may be made without departing from the invention as defined in the appended claims.

1. A coating comprising:
a latex particle comprising the reaction product of itaconic acid/anhydride and a monoalcohol wherein the latex particle comprises greater than 30% by weight of the reaction product of the itaconic acid/anhydride and monoalcohol.

2. The coating of claim 1, wherein the monoalcohol comprises 2-ethyl hexanol.

3. The coating of claim 1, wherein the reaction product further comprises a compound comprising ethylenic unsaturation.

4. The coating of claim 3, wherein the compound comprising ethylenic unsaturation is a (meth)acrylate and/or styrene.

5. The coating of claim 1, wherein the latex particle comprises 8 to 20 weight percent of the coating based on total solid weight of the coating, and filler comprises 10 to 90 weight percent of the coating based on total solid weight of the coating.

6. The coating of claim 5, wherein the fillers comprise calcium magnesium carbonate, calcium carbonate, mica, and/or wollastonite.

7. The coating of claim 1, wherein the Tg of the latex particle is −20 to +50° C.

8. A coating comprising a latex particle comprising the reaction product of itaconic acid/anhydride and a monoepoxide.

9. A coating comprising a latex particle comprising the reaction product of itaconic acid/anhydride and a monoamine.

10. The coating of claim 9, wherein the monoamine comprises an alkyl amine.

11. A coating comprising a latex particle comprising the reaction product of itaconic acid/anhydride and a monoalcohol, a monoepoxide and/or a monoamine.

12. A method for inhibiting sound and vibration transmission in a substrate, comprising applying to at least a portion of said substrate the coating of claim 1.

13. The method of claim 12, wherein the coating is applied to a non-Class A automotive surface.

14. The method of claim 13, wherein an electrocoat is applied to the substrate before the coating is applied.

15. The method of claim 12, wherein the coating, when cured, has a dry film thickness of 50 to 150 mils.

16. A method for inhibiting sound and vibration transmission through a substrate comprising applying to at least a portion of said substrate the coating of claim 8.

17. A method for inhibiting sound and vibration transmission through a substrate comprising applying to at least a portion of said substrate the coating of claim 9.

18. A method for inhibiting sound and vibration transmission through a substrate comprising applying to at least a portion of said substrate the coating of claim 11..
